(19) United States
(12) Patent Application Publication
(10) Pub. No.: US 2026/0214195 A1
(43) Pub. Date: Jul. 23, 2026

(54) METHOD FOR TAKING ROLLING HYPERSPECTRAL AND PANCHROMATIC IMAGES COMBINED BY MEANS OF A SPATIAL IMAGER

(71) Applicant: SOPHIA, Valbonne (FR)

(72) Inventors: Jean-François Blanc, Mandelieu la Napoule (FR); Guillaume Cassar, Nice (FR); Mathieu Guilhem, Saint Maur des Fossés (FR); Thomas Houllier, Antibes (FR); Nicolas Krohmer, Vence (FR)

(73) Assignee: SOPHIA, Valbonne (FR)

(21) Appl. No.: 19/140,843

(22) PCT Filed: Dec. 18, 2023
(86) PCT No.: PCT/EP2023/086482

§ 371 Date: Jun. 18, 2025

(30) Foreign Application Priority Data
Dec. 19, 2022 (FR) FR2213732

(51) Int. Cl. H04N 13/156; H04N 13/194; H04N 13/239; H04N 23/11; H04N 25/133; H04N 25/531; H04N 25/587

(52) U.S. Cl. CPC H04N 13/156; H04N 13/194; H04N 13/239; H04N 23/11; H04N 25/133; H04N 25/531; H04N 25/587

(57) ABSTRACT

The method of scanning image acquisition uses a spaceborne imager having, in its focal plane, a matrix sensor of pixels arranged in rows and columns, the matrix sensor being provided with a global shutter. Hyperspectral image acquisitions of an area of interest are performed according to different spectral bands, the hyperspectral images being obtained by acquiring successive hyperspectral frames by using the matrix sensor. Panchromatic image acquisitions of the area of interest are performed, the panchromatic images being obtained by acquiring successive panchromatic frames by using the matrix sensor, the acquired panchromatic frames exhibiting overlaps. The acquisition of hyperspectral frames and the acquisition of panchromatic frames are performed alternately, the hyperspectral frames being subjected to summation processing of successive lines of a same band within the hyperspectral zone.

### FIELD OF THE INVENTION

The present invention relates to a scanning image capture method using a spaceborne imager comprising, in its focal plane, a matrix sensor of pixels arranged in rows and columns, said matrix sensor being provided with an electronic shutter operating in global or rolling mode.

### PRIOR ART

Depending on their technical characteristics, satellite sensors record the radiation reflected or emitted by ground objects in given wavelength ranges or intervals. Spectral resolution is the sensor's ability to distinguish electromagnetic radiation of different frequencies. The finer the sensor's to sensitivity small spectral differences, i.e., narrow wavelength intervals, the higher its spectral resolution. The spectral resolution depends on the optical filtering device that decomposes the captured energy into broader or narrower spectral bands.

Panchromatic images are obtained by recording radiation in a single, wide wavelength interval, typically greater than 400 nm. As data are acquired in only one channel, only grayscale images can be obtained. If the image is encoded over 8 bits, it will be viewable in 255 shades of gray. Although less rich in terms of spectral resolution, the panchromatic image offers higher spatial resolution and a better signal-to-noise ratio.

Hyperspectral images are obtained by sensors capable of recording information in numerous spectral bands, often more than 100, which are narrower (typically a few nm wide) and often contiguous, covering the visible, near-infrared, and mid-infrared portions of the electromagnetic spectrum. Hyperspectral data thus provide more detailed information on a scene's spectral properties and allow more precise identification and discrimination of objects than broadband sensors. Each pixel of a hyperspectral image contains information large acquisition windows spread over the entire visible and infrared spectrum. The quantity of data to store and process is therefore substantial and requires greater computational capacity compared to multispectral images. Hyperspectral imaging has many applications, notably in geology, precision agriculture, forestry, aquatic environment management, and security.

According to prior art, hyperspectral bands are achieved through filters deposited close to the pixels along rows. A hyperspectral band covers h_HS rows, and the panchromatic band covers h_Pan rows of the detector or a different detector.

To increase the signal-to-noise ratio (SNR), the photons converted into electrons are summed pixel by pixel along a column over multiple successive rows. The SNR is then increased by a factor of the square root of N, where N is the number of summations. The summation, row by row, can be internal to the detector if designed accordingly, or external via dedicated readout and processing electronics, as described in patent publication CN109640012A. This technique is known as scanning acquisition by column-wise summation or “pushbroom” imaging with TDI (Time Delay Integration).

The detector's pixels convert incoming photons into electrons, which accumulate in pixel-specific wells. These wells have a limited charge capacity-called Full Well Capacity-beyond which no further accumulation is possible. Signals corresponding to acquisitions that result in saturation are typically deemed degraded or unusable.

In the case of a sensor having both panchromatic and hyperspectral pixels with identical saturation thresholds, for the same observed scene, the broader spectral width of the panchromatic band causes the panchromatic pixels' wells to fill more quickly than the hyperspectral pixels' wells. Therefore, to maximize the integrated charges in both panchromatic and hyperspectral pixels while avoiding saturation, a specific strategy must be adopted.

To prevent saturation of the panchromatic pixels, one can either attenuate the panchromatic channel's signal, for instance using a density filter, or utilize smaller panchromatic pixels. TDI summation already defined for hyperspectral frames is sometimes also applied to panchromatic frames to enhance the SNR of the panchromatic images.

Another technique consists of acquiring successive frames on a detector equipped with N spectral filters distributed across N zones along the sensor's scan direction (see patent publication US2012/300064A1). The principle involves acquiring, for each spectral band, a sequence of overlapping “snap-shot” images. The final strip consists of a sequence of overlapping sub-images (2D) for each spectral band. This acquisition method imposes constraints on the height of each spectral filter to allow proper merging of successive sub-images. The number of spectral bands is limited by the sensor height and filter height [Number of bands=H Detector/H Filter]. This technique is suitable for multispectral instruments, number of spectral bands limited to 10. It is not adapted for hyperspectral instruments (more than 50 bands), which are the subject of the present invention.

### SUMMARY OF THE INVENTION

Considering the prior art described above, a technical problem addressed by the invention is to achieve, within a single scanning acquisition, the collection of hyperspectral frames with line summation (TDI), and panchromatic frames so as to obtain hyperspectral and panchromatic images of the same area of interest, while maximizing the amount of charges integrated by the pixels through independent adjustment of the panchromatic and hyperspectral exposure times. The panchromatic frames acquired in successive “snap-shot” mode are used to enrich the hyperspectral image.

The solution proposed by the invention to this technical problem relates firstly to a scanning image capture method using a spaceborne imager comprising, in its focal plane, at least one matrix sensor of pixels arranged in rows and columns, said matrix sensor being provided with an electronic shutter, characterized in that it comprises the following steps:

Performing hyperspectral imaging of an area of interest over at least two spectral bands, the hyperspectral images being obtained by acquiring successive hyperspectral frames, using said matrix sensor associated with a summation processing over at most h_HS successive lines of the same band in the hyperspectral zone;

Performing panchromatic imaging of the area of interest, the panchromatic images being obtained by acquiring successive panchromatic frames, using said matrix sensor, wherein the acquired panchromatic frames present overlaps;

The acquisition of hyperspectral frames and panchromatic frames being performed alternately;

The alternating acquisitions being performed, while maintaining a fixed readout cadence, by replacing one hyperspectral frame with one panchromatic frame;

The number of successive hyperspectral frames acquired between two panchromatic frames being greater than or equal to the number of hyperspectral lines summed.

Advantageously:—A summation of successive panchromatic frames is performed within common areas, resulting in sub-images having a minimum overlap height between them, said sub-images being stitched to form a final panchromatic product; —A gain and offset correction is applied to the hyperspectral summation in alternate acquisition mode, and for this correction, the following is applied: let I be the level generated by an ideal pixel, with no offset and unit gain, when observing the scene, let n_{HS} be the number of frame intervals describing the alternate hyperspectral and panchromatic acquisition pattern, let kₚ ∈[1, n_{HS}] be the index of the interval in which a PAN frame has replaced a HS frame, let S=[[1, n_{HS}]]\kₚ be the set of indices of HS frames involved in the TDI summation, let (0ₖ, gₖ) be the offset and gain of the pixel of index k€[[1, n_{HS}]], these quantities being measured through laboratory and in-flight calibration acquisitions, a level measured by the pixel of index k€S est Zₖ=I·gₖ+Oₖ the sum result is: Z=Σ_{k∈S} zₖ=Σ_{k∈S} oₖ+I·Σ_{k∈S} gₖ the correction is applied to retrieve the ideal level I:

$$I = \frac{Z - {\sum }_{k ∈ S} {o}_{k}}{{\sum }_{k ∈ S} {g}_{k}} ;$$

—a selection is applied to the panchromatic frames, the selection of said frames being read on the detector(s) and, once read, stored in memory; —The selection reduces the volume of data to be processed or transmitted while maintaining performance in terms of ground area coverage; —Temporal frequencies are selected for sampling vibratory phenomena presented by the instrument's line of sight; —he hyperspectral acquisition is combined with a super-resolved panchromatic acquisition; —Instead of summing panchromatic frames to improve signal-to-noise ratio, said frames are used to improve resolution by measuring inter-frame shifts and recombining them to enhance resolution; —The hyperspectral capture is enriched by acquisitions over at least one panchromatic zone of height h_pan lines at a sufficient rate, exceeding 10 frames per second, and a video of the observed scene is acquired during the traversal time of the h_pan panchromatic lines; —The sensor comprises at least two panchromatic zones and at least one hyperspectral zone; —the exposure times of the panchromatic zones are adjusted to obtain high dynamic range acquisition; —information contained in the acquisition of a first panchromatic zone scanning the area of interest is used to adjust the exposure time and/or area of interest and/or binning application for corresponding frames of the next panchromatic zone in the scan sequence of the area of interest to optimize image quality, and/or to adjust the exposure time and/or area of interest and/or binning application for corresponding hyperspectral frames to optimize image quality; —video information is enriched by acquiring two successive videos of the same ground objects separated by a time gap between panchromatic acquisitions of the two panchromatic zones, a first zone providing video of moving objects in the scene, and the second zone indicating the direction of motion; —the hyperspectral acquisition is combined with panchromatic stereovision acquisition, using two panchromatic zones on the detector equipped with the hyperspectral filter to enrich the hyperspectral image with a stereo image of the same observed area, the stereo angle being equal to the angular offset between the two panchromatic channels multiplied by a satellite slowdown factor; —pixel binning is performed independently for hyperspectral and panchromatic images; —panchromatic images are used to improve the final resolution of the hyperspectral image through hyperspectral-panchromatic fusion processing.

The invention further relates to a spaceborne imager comprising, in its focal plane, at least one matrix sensor of pixels arranged in rows and columns, said matrix sensor being provided with an electronic shutter, for implementing the scanning image capture method defined above.

### BRIEF DESCRIPTION OF THE DRAWINGS

The invention will be better understood from the following non-limiting description, made with reference to the accompanying drawings, in which:

FIG. 1 schematically illustrates an element of a matrix sensor for implementing the method of the invention for hyperspectral image acquisition comprising 3 spectral bands;

FIG. 2 schematically illustrates an element of a matrix sensor for implementing the method of the invention for panchromatic image acquisition;

FIG. 3 schematically illustrates the implementation of the method according to the invention comprising two adjacent same sensor for panchromatic and hyperspectral image acquisition;

FIGS. 4A and 4B schematically illustrate scanning image captures performed according to the invention, with line summation in the hyperspectral zone;

FIG. 5 schematically illustrates a typical processing of panchromatic frames according to the invention;

FIG. 6 schematically illustrates alternating hyperspectral and panchromatic image captures according to the invention;

FIG. 7 shows a sequence of 11 frames read on a detector, followed by a sequence of one panchromatic frame, according to the invention;

FIGS. 8A and 8B show a configurable frame selection strategy according to the invention; and

FIG. 9 schematically illustrates a sensor comprising two panchromatic zones for implementing alternative embodiments of the invention.

### DETAILED DESCRIPTION OF THE INVENTION

The invention relates to a scanning image capture method.

This scanning image capture method is implemented using a spaceborne imager. Spaceborne imaging is a technique for remotely observing an area of interest by capturing optical domain images from space using equipment installed onboard artificial satellites. The area of interest is notably a terrestrial area.

For the image capture according to the invention, the spaceborne imager comprises, in its focal plane, one or more sensors or detectors. Since the image capture is scanning, the image moves along the columns of the detector in the focal plane.

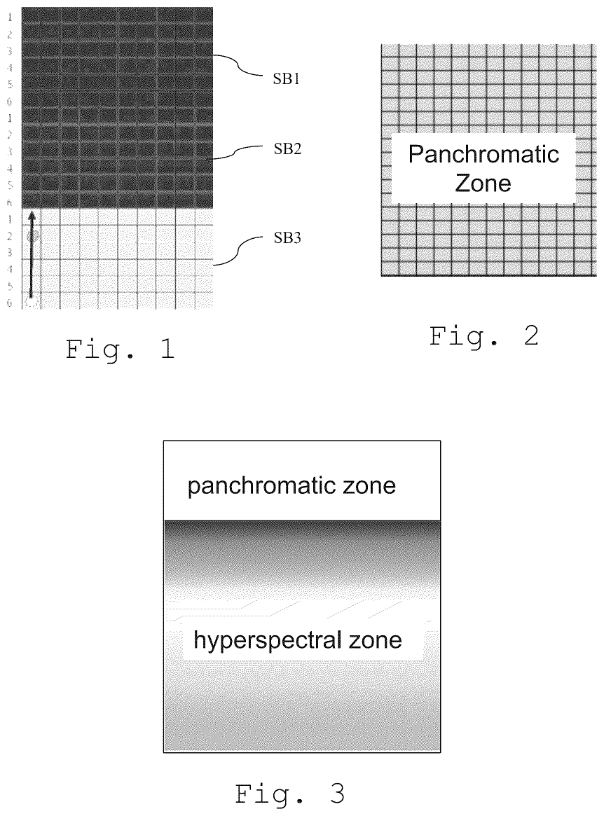

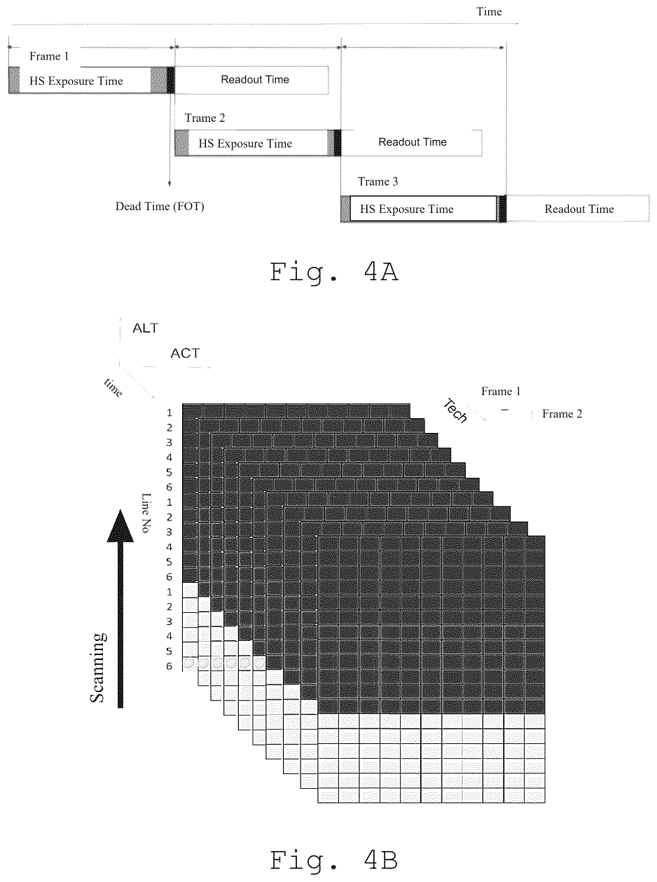

The sensor is a matrix sensor composed of pixels. It is most often a CMOS (Complementary Metal Oxide Semiconductor) sensor. As illustrated in FIGS. 1 and 2, the sensor's pixels are arranged in rows and columns.

The matrix sensor includes a hyperspectral detection zone. The hyperspectral image capture is performed over various spectral bands. In the example of FIG. 1, the sensor includes 3 pixel zones corresponding to 3 spectral bands. The imaging is thus performed over these 3 spectral bands SB: a first spectral band SB1, a second spectral band SB2, and a third spectral band SB3. In this example, the matrix sensor includes 6 rows of pixels per spectral band SB. Thus, h_Hs=6, for each spectral band SB1, SB2 et SB3.

A hyperspectral sensor is a sensor having spectral bands with bandwidths between 0.1 and 50 nm, more particularly between 2 and 20 nm, and a total number of spectral bands between 2 and 2000, more particularly between 50 and 200.

The matrix sensor further includes a panchromatic detection zone, illustrated in FIG. 2. This zone includes a number of pixel rows, for example, several hundred rows, h_Pan. According to the invention, the number of pixel columns in the panchromatic zone is advantageously equal to the number of columns in the hyperspectral zone.

The acquisition of the same area of interest in both hyperspectral and panchromatic bands is sought to maximize the acquired information and enrich the final hyperspectral products. This concerns hyperspectral-panchromatic fusion, correction of line-of-sight instabilities between hyperspectral cube images, simultaneous super-resolved hyperspectral-panchromatic acquisition, simultaneous panchromatic and hyperspectral video acquisition, simultaneous stereo panchromatic and hyperspectral acquisition, as well as real-time control and modification of acquisition parameters (exposure time, binning, area of interest, . . . ). The term “binning” is used in French. It may be translated as “data binning” or “data grouping per class.”

The invention proposes advantageously using the same sensor for both hyperspectral and panchromatic channels. Thus, the panchromatic and hyperspectral detection zones advantageously form a single unit within the sensor, as shown in FIG. 3, or may be separated into two zones.

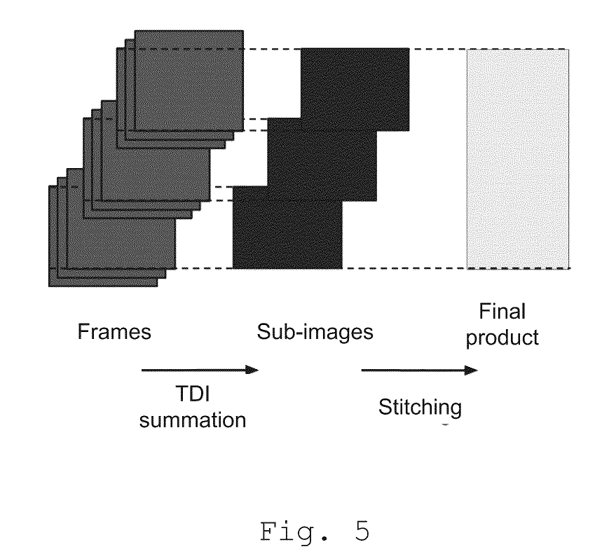

The matrix sensor according to the invention is advantageously equipped with a global electronic shutter. Shuttering occurs at each frame, i.e., at each readout. Image acquisition for the image capture is simultaneous on all pixels. It is performed at a frequency such that the delay between two frames is less than or equal to the sampling time (Frame Time)≤1/Tech with Tech=GSD (Ground Sampling Distance)×Ground Track Speed. This is diagrammed in FIG. 4A. The frame acquisition frequency equals the inverse of the sum of the exposure time and dead time. The exposure time is maximized to collect the maximum number of photons in each pixel without saturating the electron accumulation capacity. The frame acquisition frequency is adjusted to comply with the sampling time.

As illustrated in FIG. 4B, hyperspectral images are acquired in pushbroom scanning. They are obtained by acquiring n_HS successive hyperspectral frames using the matrix sensor. A summation is performed row-by-row within each band. To perform summation over at most h_HS successive lines within the hyperspectral bands, n_HS successive frames of the hyperspectral region of interest ROI_HS are acquired.

In the example of FIG. 4B, there are 3 spectral bands, each covering 6 lines. The succession of rectangular shapes representing the 3 spectral bands depicts the successive sensor readouts performed at regular intervals. 10 readouts are illustrated in FIG. 4B. The small circles represent the same ground object point viewed within the same hyperspectral band across 6 successive readouts. The reference frame shown at the top left of FIG. 4B is a spatio-temporal reference frame of the sensor, in which ALT stands for Along Track (scan direction), and ACT stands for Across Track (direction perpendicular to the scan direction or along the swath).

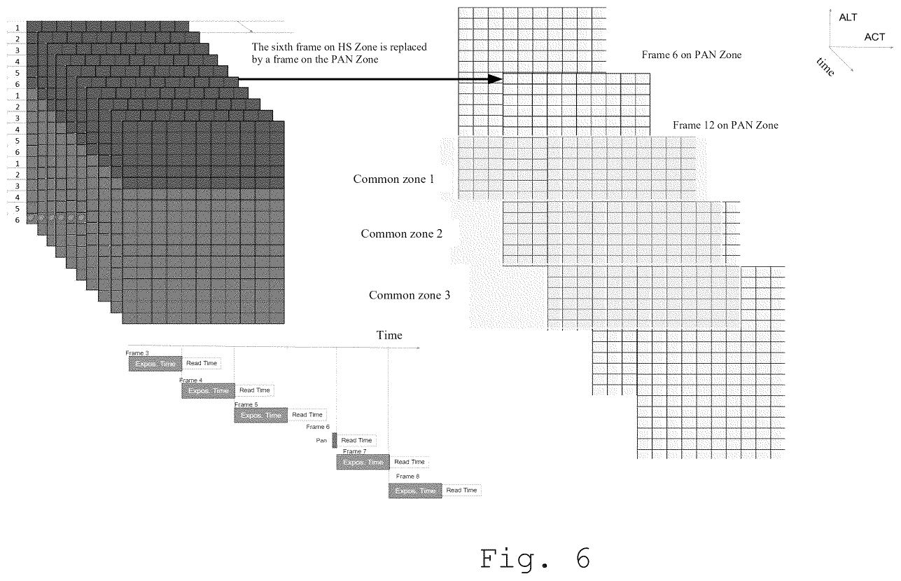

As shown in FIG. 5, panchromatic images are acquired by frames. A frame results from reading the area of interest on the sensor. The frames are successive and have a height of h_Pan, presenting overlaps. Such acquisitions are called push-frame acquisitions. The final product is an image formed from the succession of common areas, that is to say, the succession of stitched sub-images. TDI summation is performed on the common areas, resulting in sub-images having a minimal overlap height between them. This overlap allows the sub-images to be stitched together to form the final PAN product of the scene.

As schematically illustrated in FIG. 6, according to the invention, hyperspectral imaging of an area of interest ROI_HS is performed at HS acquisition times, and panchromatic imaging of an area of interest ROI_Pan is performed at Pan acquisition times. The hyperspectral and panchromatic scanning acquisitions are performed with summation. The combined hyperspectral/panchromatic scanning acquisitions are multipurpose. The method according to the invention thus proposes a mixed scanning acquisition combining line summation on narrow spectral bands and advanced frame processing on wide spectral bands. Line summation is performed within each spectral band.

The sensor is controlled to alternate the acquisition of the hyperspectral region ROI_HS (Region Of Interest HS), with an HS exposure time, and the acquisition of the panchromatic region ROI_Pan (Region Of Interest Pan) with a Pan exposure time.

The acquisition of n_HS hyperspectral frames and n Pan panchromatic frames is performed alternately. Furthermore, at least one of the n Pan panchromatic frames is inserted within the n_HS hyperspectral frame acquisition. In other words, in the example of FIG. 6, one readout is replaced by a panchromatic readout every six hyperspectral readouts, while maintaining a fixed readout cadence and maximizing the exposure time of the HS frames. This operation is only possible on detectors capable of Integration While Read (IWR), allowing the exposure of frame n in parallel with the readout of frame n−1.

The number of successive hyperspectral frames n_HS acquired between two panchromatic frames is greater than or equal to the number of hyperspectral lines summed (typically equal).

Thus, there is one panchromatic frame for every hyperspectral frames. The common areas shown in this figure are the common areas between two successive pan frames.

The panchromatic PAN frames to be retained are calculated to ensure overlap between the summed common Pan zones. The panchromatic surplus PAN frames are discarded.

### Selection of Panchromatic Frames

The insertion of the panchromatic PAN frame may be performed every n_HS frames or multiples thereof. The maximum hyperspectral summation number is in this case n_HS−1. Since n_HS is typically much smaller than the height h_Pan of the acquired PAN frames, it is possible to acquire the PAN frames sparsely while still ensuring complete coverage of the scene to be observed. There remains an interest in acquiring several redundant frames. This allows performing TDI summations between frames in order to improve the signal-to-noise ratio of the final product.

An example of a strategy for selecting panchromatic frames to acquire is given in the following paragraphs.

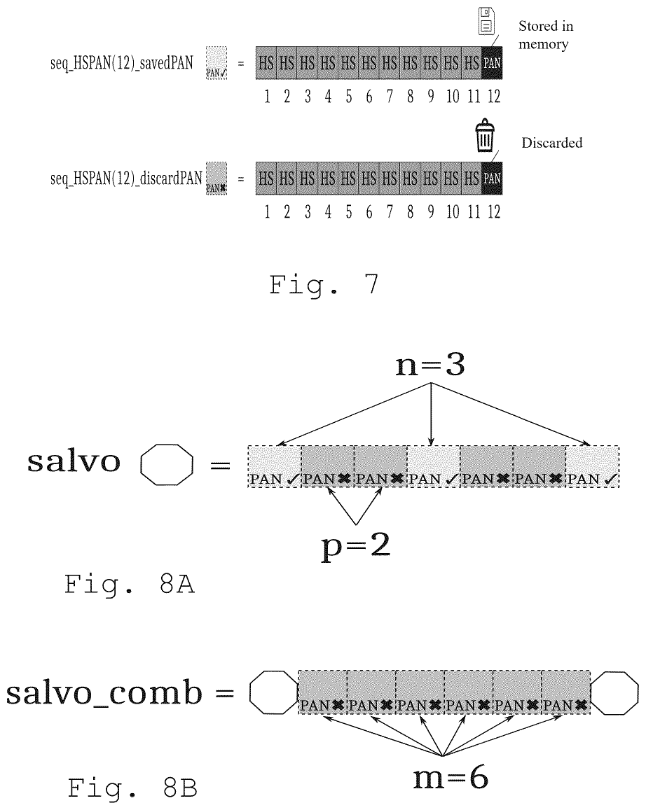

FIG. 7 describes a sequence of 11 HS frames read on a detector, followed by a panchromatic frame. The panchromatic frame may be saved or discarded depending on the panchromatic frame selection strategy. seq_HSPAN(12)_savedPAN designates a sequence in which the panchromatic frame is saved, seq_HSPAN(12)_discardPAN designates a sequence in which the panchromatic frame is discarded.

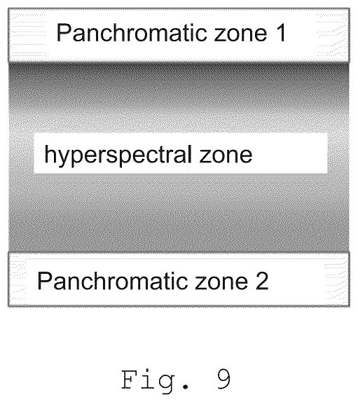

A configurable selection strategy is that defined by the sequence salvo comb (n, m, p), which is illustrated in FIG. 8A. salvo (n, p) is defined by the sequence of n seq_HSPAN(12)_savedPAN between which are interleaved p seq_HSPAN(12)_discardPAN. In FIG. 8A, n=3 and p=2.

As illustrated in FIG. 8B, the salvo comb (n, m, p) sequence is defined as the sequence containing one salvo (n, p) followed by m seq_HSPAN(12)_discardPAN.

### Hyperspectral Image Equalization Correction

The insertion of PAN frames has the consequence of modifying, for each spectral band, the distribution of the n_HS−1 lines to be summed. The result is an error on the pixel-by-pixel correction. Each pixel of the sensor, indexed by (i, j), presents an offset response characteristic o (i, j) and a gain g (i, j). o (i, j) and g (i, j) are measured, in the laboratory or in flight, by calibration acquisitions. The processing of raw data output from the instrument requires applying a correction dependent on this calibrated pixel characteristic. For processing bandwidth reasons, the correction must be applied to the HS TDI sums and not to the individual pixels. Due to the alternate HS+PAN acquisition mode, the HS TDI sums involve (n_HS−1) pixels among n_HS. The indices of the pixels involved in the HS TDI sum are known a priori and allow selecting the calibration data to be applied to the result as part of the correction.

The processing of hyperspectral frames alternate acquisition mode with the panchromatic frames is made more complex by the use of Time Delay Integration (TDI), particularly when a correction of pixel offsets and gains must be applied to the sum.

For gain and offset correction on the HS TDI sum in alternate HS+PAN acquisition mode:
let I be the level generated by an ideal pixel, which has no offset and unit gain, during observation of the scene to be measured,
let n_{HS} be the number of frame intervals describing the HS+PAN acquisition pattern,
let kₚ€[1, n_{HS}] be the index of the interval in which a PAN frame has replaced a HS frame,
let S=[[1, n_{HS}]]\kₚ be the set of HS frame indices involved in the TDI summation,
let (0ₖ, gₖ) be the offset and gain of the pixel of index k€[[1, n_{HS}]], these quantities being measured by laboratory and in-flight calibration acquisitions,
the level measured by the HS pixel of index k€S est Zₖ=I·gₖ+Oₖ,
the HS TDI sum result is:

$$Z = {\sum }_{k ∈ S} {z}_{k} = {\sum }_{k ∈ S} {o}_{k} + I \cdot {\sum }_{k ∈ S} {g}_{k}$$

the application of the correction to the HS TDI sum is performed so as to recover the ideal level

$$I : I = \frac{Z - {\sum }_{k ∈ S} {o}_{k}}{{\sum }_{k ∈ S} {g}_{k}}$$

### Fusion Hyperspectrale-Panchromatique

The mixed panchromatic-hyperspectral acquisition of the same ground scene gives access to a final product obtained by ground processing called hyperspectral-panchromatic fusion (“pansharpening” in English). The panchromatic image, containing typically higher spatial resolution information, is then used as a support to be “colored” using one or more narrow spectral bands. The result is a hyperspectral image endowed with the spatial resolution of the panchromatic image. By combining with a more resolved panchromatic acquisition via super-resolution processing or binning described later, a super-resolved hyperspectral image can be obtained.

### Jitter Correction Between the Images of a Hyperspectral Cube

The co-location on the same sensor of the hyperspectral and panchromatic bands is sought in order to improve combined spatial coregistration and to allow correction of line-of-sight shifts between the acquired hyperspectral frames.

Indeed, the panchromatic frames acquired in push-frame mode have strong geometric rigidity since all the pixels of the sub-images are acquired simultaneously, and successive sub-images can be realigned simply by correlation processing in the overlap zone between successive sub-images.

Each spectral image of the hyperspectral cube is formed line by line and may shift over time due to platform instabilities. The panchromatic frames acquired alternately with the hyperspectral frames serve as a geometric base for realigning the hyperspectral lines. The maximum accessible realignment frequency is the period of acquisition of the panchromatic frames. The realignment processing is preferably performed on the ground.

### Simultaneous Panchromatic and Hyperspectral Video Acquisition

In another embodiment of the invention, hyperspectral HS acquisition is combined with video acquisition. In such a case, instead of summing the panchromatic PAN frames to improve the signal-to-noise ratio (“Signal to Noise Ratio” or “SNR”), the PAN frames are used to produce a video of the observed area. The video frame rate equals the acquisition rate of the panchromatic frames, typically 20 frames per second (fps). The observation duration is the scanning time of the panchromatic zone, typically 1 s. Video acquisition can be performed on one or more panchromatic zones.

As shown in FIG. 9, advantageously, a detector comprising at least two panchromatic zones, namely a Panchromatic Zone 1 and a Panchromatic Zone 2, is used. This allows enriching the video information providing two successive videos of the same ground objects separated by the time interval between the panchromatic acquisitions of Panchromatic Zones 1 and 2, which is typically 5 s. In one example, the video obtained by Panchromatic Zone 1 allows visualizing the moving objects in the observed scene, while Panchromatic Zone 2 provides information on the direction followed.

In another embodiment of the invention, similarly, a detector comprising two separate panchromatic zones, namely a Panchromatic Zone 1 and a Panchromatic Zone 2, is used. However, in this embodiment, hyperspectral HS acquisition is combined with panchromatic stereoscopic (stereo) acquisition. The use of two panchromatic zones on the detector equipped with the hyperspectral filter allows enriching the hyperspectral image with a stereo image of the same observed area. The stereo angle B/H is equal to the angular separation between the two PAN channels multiplied by the satellite slowdown factor. Typically, a stereo angle B/H that can be achieved is 0.12.

### Simultaneous Super-Resolved Panchromatic-Hyperspectral Acquisition

In another embodiment of the invention, hyperspectral HS acquisition is combined with super-resolved panchromatic acquisition. In such a case, instead of summing the panchromatic frames to improve the SNR, they are used to improve resolution by performing inter-frame shift measurements and recombining the frames, thus taking advantage of spatial sampling to improve resolution. This embodiment is adapted to hyperspectral imagers, which have a low f-number to maximize photon count, and thus exhibit a high optical modulation transfer function cutoff. The resolution gain is at least a factor of 1.5.

### Control and Modification of Acquisition Parameters (Exposure Time, Binning, Area of Interest, Etc.) During Image Acquisition

Due to the movement of the image on the sensor of the spaceborne imager, the panchromatic image is acquired before the hyperspectral image. A reasonable delay separating these two acquisitions is from a few milliseconds to several seconds. This allows real-time processing to optimize the quality of the images acquired on the following hyperspectral and/or panchromatic zones. The information from the panchromatic pixels (signal level, distribution) may be used to modify the sensor acquisition parameters for the subsequent frames, according to thresholds, in order to improve, for example, the SNR by increasing the exposure time, improve the GSD by disabling binning, or select the panchromatic frames.

In conclusion, the invention offers numerous advantages. In particular, the invention makes it possible:
to acquire panchromatic frames at very high frequency, interleaved with hyperspectral HS frames. This allows, by ground processing, the correction of interband geometric drifts related to satellite instabilities during the spectral acquisition horizon. This relaxes the long-term stability constraints on the platform;
to access panchromatic images with a dynamic range adapted for the panchromatic channel since the panchromatic acquisition times may be modified. Thus, the panchromatic image signal-to-noise ratio can be improved, or panchromatic high dynamic range (“HDR”) acquisitions made possible;
to obtain, in certain embodiments of the invention, panchromatic video images simultaneously with the hyperspectral image acquisition;
to obtain native stereo images simultaneously with the hyperspectral image;
to increase panchromatic resolution through ground processing with oversampling, using images acquired simultaneously with the hyperspectral image;
to implement intelligent operating modes allowing the improvement of image quality performance by exploiting information received by the first panchromatic zone;
to access better resolved hyperspectral products through ground-based hyperspectral-panchromatic fusion processing (“pansharpening”).

The invention thus allows mixing, on a same sensor and quasi-simultaneously, push-frame acquisition on the panchromatic zone and pushbroom acquisition (with posterior line summation) on the spectral filter-equipped zone, while maintaining a fixed sensor readout rate by replacing one hyperspectral frame with one panchromatic frame and allowing the acquisition of at least 50 spectral bands.

1. A scanning image capture method using a spaceborne imager comprising, in a focal plane thereof, at least one matrix sensor of pixels arranged in rows and columns, the matrix sensor being provided with an electronic shutter, wherein the method comprises:
performing hyperspectral imaging of an area of interest over at least 50 spectral bands, the hyperspectral images being obtained by acquiring successive hyperspectral frames using the matrix sensor associated with summation processing over at most h_HS successive lines of the same band within the hyperspectral zone; and
performing panchromatic imaging of the area of interest, the panchromatic images being obtained by acquiring successive panchromatic frames using the matrix sensor, the acquired panchromatic frames exhibiting overlap;
wherein the acquiring of the hyperspectral frames and snapshot acquiring of panchromatic frames are performed alternately while maintaining a fixed readout cadence, by replacing one hyperspectral frame with one panchromatic frame; and
wherein a number of successive hyperspectral frames acquired between two panchromatic frames is greater than or equal to a number of hyperspectral lines summed.

2. The method according to claim 1, comprising performing a summation of successive panchromatic frames within common areas, resulting in sub-images having a minimum overlap height therebetween, the sub-images being stitched together to form a final panchromatic product.

3. The method according to claim 1, wherein gain and offset correction is applied to an hyperspectral summation in alternate acquisition mode, and wherein, for the gain and offset correction, the following is applied:
I being a level generated by an ideal pixel, which presents no offset and has unit gain, during observation of the scene;
n_{HS} being number of frame intervals describing an alternate hyperspectral and panchromatic acquisition pattern;
kₚ€[[1, n_{HS}]] being an interval index where a PAN frame replaced a HS frame;
S=[[1, n_{HS}]]\kₚ being a set of HS frame indices involved in a time delay integration (TDI) summation,
(0ₖ, gₖ) being an offset and gain of a pixel of index k€[[1, n_{HS}]], these quantities measured by laboratory and in-flight calibration acquisitions,
a level measured by a pixel of index k€S being Zₖ=I·gₖ+Oₖ
a sum result being: Z=E_{k∈S}zₖ=Σκ_{k∈S}oₖ+I·Σ_{k∈S}gₖ
an application of a correction to the sum result is performed so as to recover an ideal level
$$I = \frac{Z - {\sum }_{k ∈ S} {o}_{k}}{{\sum }_{k ∈ S} {g}_{k}} .$$

4. The method according to claim 1, wherein a selection is performed on the panchromatic frames, said selection of frames being read from one or more detectors and, once read, saved into a memory.

5. The method according to claim 4, wherein the selection reduces the volume of data to be processed or transmitted while maintaining performance in terms of coverage of a ground area to be acquired.

6. The method according to claim 1, wherein a registration processing is performed on the hyperspectral lines to correct jitter.

7. The method according to claim 1, wherein the hyperspectral acquiring is combined with a super-resolved panchromatic acquisition.

8. The method according to claim 1, wherein, instead of summing panchromatic frames to improve signal-to-noise ratio, the frames are used to improve resolution by performing inter-frame shift measurements and recombining the inter-frame shift measurements to enhance resolution.

9. The method according to claim 1, wherein the hyperspectral image capture is enriched by acquisitions over at least one panchromatic zone of height h_pan panchromatic lines at a sufficient rate exceeding 10 frames per second, and a video of the observed scene is acquired during scanning duration of the h_pan panchromatic lines.

10. The method according to claim 1, wherein the sensor comprises at least two panchromatic zones and at least one hyperspectral zone.

11. The method according to claim 10, wherein exposure times of the panchromatic zones are adjusted to obtain a high dynamic range acquisition.

12. The method according to claim 10, wherein information contained in the acquisition of a first panchromatic zone scanning an area of interest is used to adjust exposure time and/or area of interest and/or binning application for corresponding frames of a next panchromatic zone in a scan sequence of the area of interest to optimize image quality, and/or to adjust the exposure time and/or area of interest and/or binning application for corresponding hyperspectral frames to optimize image quality.

13. The method according to claim 10, wherein video information is enriched by acquiring two successive videos of a same ground objected separated by a time interval between panchromatic acquisitions of two panchromatic zones, a video from a first panchromatic zone visualizing moving objects in an observed scene, and a video from a second panchromatic zone indicating movement direction.

14. The method according to claim 10, wherein the hyperspectral acquisition is combined with a panchromatic stereovision acquisition, wherein use of two panchromatic zones on the detector equipped with the hyperspectral filter enriches the hyperspectral image with a stereo image of the same observed area, a stereo angle being equal to an angular offset between two panchromatic channels multiplied by a satellite slowdown factor.

15. The method according to claim 1, wherein panchromatic images are used to improve a final resolution of a hyperspectral image through hyperspectral-panchromatic fusion processing.

16. A spaceborne imager comprising, in a focal plane thereof, at least one matrix sensor of pixels arranged in rows and columns, the matrix sensor being provided with an electronic shutter, for implementing a scanning image capture method comprising:
performing hyperspectral imaging of an area of interest over at least 50 spectral bands, the hyperspectral images being obtained by acquiring successive hyperspectral frames using the matrix sensor associated with summation processing over at most h_HS successive lines of the same band within the hyperspectral zone; and
performing panchromatic imaging of the area of interest, the panchromatic images being obtained by acquiring successive panchromatic frames using the matrix sensor, the acquired panchromatic frames exhibiting overlap;
wherein the acquiring of the hyperspectral frames and snapshot acquiring of panchromatic frames are performed alternately while maintaining a fixed readout cadence, by replacing one hyperspectral frame with one panchromatic frame; and
wherein a number of successive hyperspectral frames acquired between two panchromatic frames is greater than or equal to a number of hyperspectral lines summed.

17. The method according to claim 2, wherein gain and offset correction is applied to an hyperspectral summation in alternate acquisition mode, and wherein, for the gain and offset correction, the following is applied:
I being a level generated by an ideal pixel, which presents no offset and has unit gain, during observation of the scene;
n_{HS} being number of frame intervals describing an alternate hyperspectral and panchromatic acquisition pattern;
kₚ€[[1, n_{HS}]] being an interval index where a PAN frame replaced a HS frame;
S=[[1, n_{HS}]]\kₚ being a set of HS frame indices involved in a time delay integration (TDI) summation,
(0ₖ, gₖ) being an offset and gain of a pixel of index k€[[1, n_{HS}]], measured by laboratory and in-flight calibration acquisitions,
a level measured by a pixel of index k€S being Zₖ=I·gₖ+Oₖ a sum result being: Z=Σ_{k∈S} zₖ=Σ_{k∈S}oₖ+I·Σ_{k∈S}gₖ an application of a correction to the sum result is performed so as to recover an ideal level
$$I = \frac{Z - {\sum }_{k ∈ S} {o}_{k}}{{\sum }_{k ∈ S} {g}_{k}} .$$

18. The method according to claim 17, wherein a selection is performed on the panchromatic frames, said selection of frames being read from one or more detectors and, once read, saved into a memory.

19. The method according to claim 2, wherein a selection is performed on the panchromatic frames, said selection of frames being read from one or more detectors and, once read, saved into a memory.

20. The method according to claim 3, wherein a selection is performed on the panchromatic frames, said selection of frames being read from one or more detectors and, once read, saved into a memory.
